(19) United States
(12) Patent Application Publication
(10) Pub. No.: US 2014/0089458 A1
(43) Pub. Date: Mar. 27, 2014

(54) NETWORK STORAGE SYSTEM WITH FLEXIBLE DRIVE SEGMENTATION CAPABILITY

(71) Applicants: Peter Alexander CARIDES, San Diego, CA (US); Barry R. ROBBINS, Carlsbad, CA (US)

(72) Inventors: Peter Alexander CARIDES, San Diego, CA (US); Barry R. ROBBINS, Carlsbad, CA (US)

(21) Appl. No.: 13/628,403

(22) Filed: Sep. 27, 2012

(51) Int. Cl. H04L 29/08

(52) U.S. Cl. CPC H04L 67/1097
USPC 709/217

(57) ABSTRACT

A storage system for storing and retrieving data streams from a plurality of networked devices in real-time can include a plurality of solid-state memory devices (SSDs), a plurality of storage processors and an interface processor. Each storage processor is connected to the interface processor, and, once the storage system is configured, each storage processor is connected to one or more SSD's. The particular number of SSD's that are addressed by each storage processor depends on the storage system configuration and changes when the storage system is reconfigured. With the arrangement described above, the storage system is segmented into a plurality of individual drives with each individual drive including a storage processor and the individual SSDs that are connected to and addressed by the storage processor. To optimize storage speed and efficiency, the interface processor can then route the data streams from one or more networked devices to a particular individual drive.

### FIELD OF THE INVENTION

The present invention pertains generally to network storage systems. More particularly, the present invention pertains to network storage systems for storing and retrieving data streams in real-time. The present invention is particularly, but not exclusively, useful as a storage system that can be flexibly segmented into a plurality of individual drives to efficiently store and retrieve a plurality of data streams in real-time.

### BACKGROUND OF THE INVENTION

Modern aircraft, ships and other vehicles often employ sensors, cameras and other networked devices which operate continuously or nearly continuously. Real time capture of these high bandwidth data streams can present specialized data storage challenges. These problems are compounded as the number of sensors, cameras and other networked devices increase.

Real time data storage and retrieval implies a high-speed memory device that is large enough to accommodate a substantial amount of data. In this regard, individual drives may be suitable in certain applications. On the other hand, a common network storage system offers several advantages including accessibility, centralized encryption and ease of data backup.

To extend their useful service life, aircraft, ships and other vehicles are often updated and/or modernized with new equipment. This updating can include the addition of networked devices such as sensors and cameras and/or replacement pre-existing networked devices. These new sensors/cameras often have a higher bandwidth output than their predecessors and can present new challenges to an existing network storage system. This is particular so when the existing network storage system has an architecture that was specifically designed to accommodate the originally installed networked devices and is not reconfigurable.

In light of the above, it is an object of the present invention to provide a network storage system for efficiently storing and retrieving high bandwidth data streams in real-time. Another object of the present invention is to provide a storage system that can be flexibly segmented into a plurality of individual drives to efficiently store data streams from a plurality of networked devices. Still another object of the present invention is to provide a storage system that can be reconfigured to efficiently and easily accommodate changes to the number and/or type of devices generating data streams that require storage. Yet another object of the present invention is to provide a Network Storage System With Flexible Drive Segmentation Capability and corresponding methods of use which are easy to use, relatively simple to implement, and comparatively cost effective.

### SUMMARY OF THE INVENTION

In accordance with the present invention, a storage system for storing and retrieving data streams from a plurality of networked devices in real-time includes a plurality of solid-state memory devices (SSD's). By way of example, the system may include 64 SSD's, with each SSD having a storage capacity of 1 Terabyte (TB).

For the storage system of the present invention, an interface is provided having an interface processor. The interface is connected to one or more networks allowing data to be received by the storage system from different types of networked devices. In particular, the interface allows the storage unit to receive high bandwidth data streams from networked devices such as cameras, sensors and video encoder equipment and allows for the retrieval of data from the storage unit.

In addition to the interface processor, the system includes a plurality of storage processors. Each storage processor is connected to the interface processor and, once the storage system is configured, each storage processor is connected to one or more SSD's. The particular number of SSD's that are addressed by each storage processor depends on the storage system configuration and changes when the storage system is reconfigured. Typically, an individual SSD is not addressed by more than one storage processor.

With the arrangement described above, the storage system is segmented into a plurality of individual drives. Specifically, each individual drive includes a storage processor and the individual SSDs that are connected to and addressed by the storage processor. To optimize storage speed and efficiency, the interface processor can then route the data streams from one or more networked devices to a particular individual drive.

The initial configuration and reconfiguration of a storage system can perhaps best be understood by way of an example. For this example, consider a storage system having 16 storage processors and 64 SSD's. Initially, for this example, four networked devices, such as two cameras and two sensors, may be connected to a network and operated to generate four high bandwidth data streams that are received by the interface processor. To accommodate these four networked devices, an initial storage system configuration may include an architecture in which four storage processors are each connected to and address 16 SSD's (4 by 16 architecture). With this arrangement, each data stream is routed to one or four individual drives.

Continuing with the above example, the storage system may be reconfigured to accommodate the addition of two new cameras and two new sensors for a total of eight networked devices. The new storage system configuration may include an architecture in which eight storage processors are each connected to and address 8 SSD's (8 by 8 architecture). With this arrangement, each data stream is routed to one or eight individual drives.

For the present invention, the reconfiguration may be accomplished in one of several ways. In a first implementation, the interface processor can include logic to reconfigure the storage system when a networked device is installed on the network. For example, the interface processor can detect the new data stream (and in some cases measure its bandwidth) and reconfigure the storage system accordingly. This can involve sending instructions to the storage processors to redistribute the SSD's. The routing paths for each data stream from the interface processor to the SSD's may also be altered.

In another implementation, a user input can be provided to allow a user to reprogram the interface processor logic and reconfigure the storage system by creating new individual drives, modifying existing individual drives and/or assigning/reassigning individual drives to specific networked devices. Another implementation can include a hardware change. For example, a socket to the interface may be provided. Removable circuits (e.g. memory cards) having specific storage processor/SSD architectures (i.e. 4 by 16, 8 by 8, etc . . . ) may then be interchanged using the socket to reconfigure the storage system.

The interface processor can also include logic to reconfigure the storage capacity of individual drives when a storage level in one of the individual drives exceeds a predetermined amount.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an aircraft having a portion of its fuselage cutaway to reveal a network storage system in accordance with the present invention;

FIG. 2 shows a simplified schematic illustrating an onboard aircraft network having networked devices such as sensors and cameras and a network storage system; and

FIG. 3 shows a schematic of a reconfigurable network storage system in accordance with the present invention.

### DESCRIPTION OF THE PREFERRED EMBODIMENTS

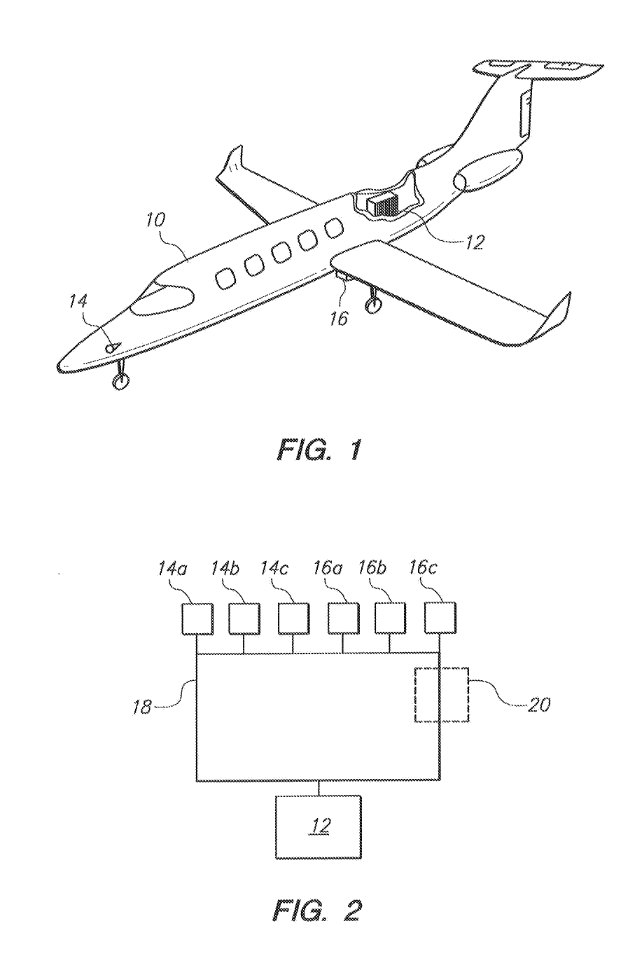

Referring initially to FIG. 1, an aircraft 10 is shown that is equipped with a data storage system 12 in accordance with the present invention. Although the storage system 12 is described herein can be ruggedized for use with an aircraft, it is to be appreciated that the storage system 12 can be used in other applications in which it is desired to capture and store a plurality of high bandwidth data streams. For example, the storage system may be used on ships, ground vehicles and on-location film production sets. Continuing with FIG. 1, it can be seen that the aircraft 10 is equipped with a sensor 14 and camera 16. Cross-referencing FIGS. 1 and 2, it can be seen that the sensors 14 and cameras 16 are operably connected to a network 18. For example, the sensors 14 can provide a measurement of an outside condition or airspeed, an aircraft's position or attitude, an aircraft control system setting or the changing state of the aircraft's communication systems links. The network 18 interconnecting networked devices (i.e. sensors 14 and cameras 16) can include wires, co-axial or fiber optic cables, buses or wireless connections. For example, the network 18 can be a local area network (LAN) such as an Ethernet LAN, and in particular, can be a 10 or 100 Gigabit Ethernet LAN. Optional external interfaces to the storage system 12 can include eSATA (Serial Advanced Technology Attachment), SAS×4 SF-8080 (each connector exposes 4 SATA drives), infiniband, PCI express, PCI express over cable and FibreChannel.

Although six networked devices (i.e. sensors 14a-c and cameras 16a-c) are shown in FIG. 2 on a single network 18, it is to be appreciated that more than 6 and as few as two networked devices may be used with the present invention, that more than one network may be employed, and the networks may be different types (i.e. connection type/protocol). Moreover, the network devices may all be of the same type (i.e. all cameras) or may differ in type (some cameras and some sensors). FIG. 2 also shows an example of an optional device 20 that is connected to the network 18, which can be, for example, a processor having a user interface, a satellite link, etc . . . Other than sensors and cameras, other networked devices can include video encoding systems and content servers.

It is to be further appreciated that more than one storage system 12 may be used on a vehicle, such as an aircraft, and the storage systems 12 may be part of a common network or the storage systems 12 may reside on different networks.

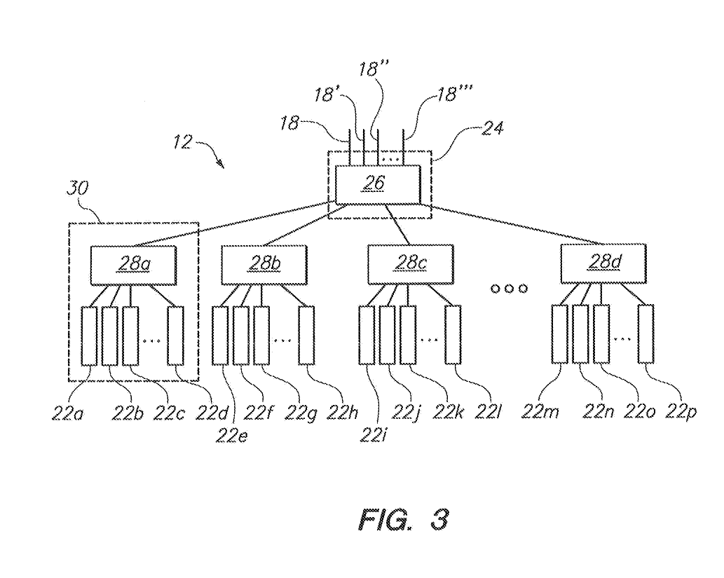

FIG. 3 shows the components of a reconfigurable storage system 12 in greater detail. As seen there, the storage system 12 includes a plurality of solid state memory devices 22a-p (SSD). For example, each SSD 22a-p can be a SATA3 based DIMM solid state device having a storage capacity of 512 GB or 1 Terabyte (TB). For the storage system 12, an interface 24 is provided having an interface processor 26. The interface is connected to one or more networks such as networks 18, 18′, 18″, 18′″ allowing data to be received by the storage 12 system from networked devices. As indicated above, external interfaces can be one or more of Ethernet LAN, eSATA (Serial Advanced Technology Attachment), SAS×4 SF-8080 (each connector exposes 4 SATA drives), infiniband, PCI express, FibreChannel or any other external interface known in the pertinent art and suitable for the applications described herein.

FIG. 3 also shows that the storage system 12 includes a plurality of storage processors 28a-d. Each storage processor 28a-d is connected to the interface processor 26 (e.g. using a SATA connection), and, once the storage system 12 is configured, each storage processor 28a-d is connected (e.g. using a SATA connection) to and able to address, for purposes of storage and/or retrieval, the memory within one or more SSDs 22a-p. Although four storage processors 28a-d are shown, it is to be appreciated that more than four and as few as two storage processors 28a-d may be used in the storage system 12. The interface processor 26 and storage processors 28a-d can each be, for example, an integrated CPU board having quad-core 2.8 Ghz Xeon or i7 processor and can include 8 GB RAM, 4 GB Flash, Dual Ethernet and Quad USB. In some cases, the interface processor 26 may be of a different type than the storage processors 28a-d. Other processors known in the art to be suitable for the application described herein may be used. In some instances, the storage system 12 can be configured such that data can be written to the array of solid state memory devices 22a-p (SSD) purely in hardware, thus avoiding any CPU latency. The storage system 12 can be used with non-networked interfaces, e.g. direct serial (I/O) such as Fibre Channel, PCI express and PCI express over cable.

For the storage system 12, the particular number of SSDs 22a-p that are addressed by each storage processor 28a-d depends on the configuration of the storage system 12 and changes when the storage system 12 is reconfigured. Typically, as shown, an individual SSD 22a-p is not addressed by more than one storage processor 28a-d.

FIG. 3 also illustrates that the storage system 12 is segmented into a plurality of individual drives 30 (embodiment with four individual drives shown). Specifically, each individual drive 30 includes a storage processor 28a-d and the individual SSDs 22a-p that are connected to and addressed by the storage processor 28a-d. To optimize storage speed and efficiency, the interface processor 26 can then route the data streams from one or more networked devices to a particular individual drive 30.

While the particular Network Storage System With Flexible Drive Segmentation Capability and corresponding methods of use as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A storage system for storing data streams from a plurality of networked devices in real-time, said storage system comprising:
a plurality of solid state memory devices;
an interface having an interface processor for receiving the data streams over a network; and
a plurality of storage processors, each storage processor connected to the interface processor and connected to an adjustable fraction of said plurality of solid state memory devices to flexibly segment the storage system into a plurality of individual drives, with at least one individual drive dedicated to a discrete number of networked devices.

2. A storage system as recited in claim 1 wherein each solid state memory device is a SATA3 based DIMM solid state device.

3. A storage system as recited in claim 1 wherein each storage processor is connected to a same number of solid state memory devices.

4. A storage system as recited in claim 1 wherein the network storage device is segmented to optimize storage speed.

5. A storage system as recited in claim 1 wherein at least one of the networked devices is a camera.

6. A storage system as recited in claim 1 wherein at least one of the networked devices is a sensor.

7. A storage system as recited in claim 1 wherein the number of networked devices is more than four.

8. A storage system as recited in claim 1 wherein the system automatically reconfigures the number of individual drives as a function of the number of data streams received at the interface.

9. A storage system as recited in claim 1 wherein the system is user programmable to reconfigure the number of individual drives in response to the number of data streams received at the interface.

10. A storage system as recited in claim 1 wherein the system automatically reconfigures the storage capacity of at least two individual drives when a storage level in one of the individual drives exceeds a predetermined amount.

11. A storage system as recited in claim 1 wherein each individual drive is dedicated to a respective networked device.

12. A storage system for storing data streams from a plurality of networked devices in real-time, said storage system comprising:
a plurality of solid state memory devices;
an interface means for receiving the data streams, each data stream received from a different networked device;
a plurality of storage processors; and
a means for connecting each storage processor to the interface means and to a selected fraction of said solid state memory devices to flexibly segment the network storage device into a plurality of individual drives, with at least one individual drive dedicated to a discrete number of networked devices.

13. A network storage system as recited in claim 12 wherein the system automatically reconfigures the number of individual drives in response to the number of data streams received at the interface.

14. A network storage system as recited in claim 12 wherein the system is user programmable to reconfigure the number of individual drives in response to the number of data streams received at the interface.

15. A network storage system as recited in claim 12 wherein the system automatically reconfigures the storage capacity of at least two individual drives when a storage level in one of the individual drives exceeds a predetermined amount.

16. A method for storing a plurality of data streams in real-time, said method comprising the steps of:
providing a plurality of solid state memory devices;
receiving the data streams at an interface, each data stream received from a different networked device;
establishing a connection between the interface and a plurality of storage processors; and
connecting each storage processor to a selected fraction of said solid state memory devices to flexibly segment the network storage device into a plurality of individual drives, with at least one individual drive dedicated to a discrete number of networked devices.

17. A method as recited in claim 16 wherein each solid-state memory device is a SATA3 based DIMM solid-state device.

18. A method as recited in claim 16 wherein the connection step reconfigures the number of individual drives in response to the number of data streams received at the interface.

19. A method as recited in claim 16 wherein the connection step includes the sub-step of programming the number of individual drives in response to the number of data streams received at the interface.

20. A method as recited in claim 16 wherein the connection step reconfigures the storage capacity of at least two individual drives when a storage level in one of the individual drives exceeds a predetermined amount.
